(19) United States
(12) Patent Application Publication
(10) Pub. No.: US 2009/0080677 A1
(43) Pub. Date: Mar. 26, 2009

(54) Stringed instrument with simulator preamplifier

(76) Inventors: Stephen P. Webster, Oakville (CA); Craig A. Small, Framingham, MA (US)

Correspondence Address: Richard D. Zimmerman;Chace Ruttenberg & Freedman, LLP, Suite 300, One Park Row, Providence, RI, 02903, US

(21) Appl. No.: 11/903,672

(22) Filed: Sep. 24, 2007

(51) Int. Cl. G10H 1/00

(52) U.S. Cl. 381/118

(57) ABSTRACT

A stringed instrument and preamplifier combination where the preamplifier simulates the sound of analog tube amplifiers, and contains only solid state active devices. The preamplifier uses a diode branch with the diode biased into its forward active region and as a non-linear resistive element to provide signal-modulated gain on the operational amplifier gain stage. An alternative embodiment supplements the diode branch with series and parallel resistors as additional design optimization parameters. Another alternative embodiment adds symmetrical output clipping diodes to simulate a vacuum tube push-pull output independently of the diode branch.

### FIELD OF INVENTION

This invention concerns stringed instruments with built-in preamplifiers. The instrument-preamplifier combination is designed for amplification through a hi-fidelity stereo system, and more particularly, through an automobile stereo system.

### BACKGROUND

Stringed instruments, including guitars, incorporating preamplifiers are known. Guitar players frequently seek to duplicate the sound of vacuum tube based amplifiers, which sound is recognized as important to the classic rock guitar sound. Preamplifiers that substantially reproduce the classic vacuum tube sound are known. What is needed is a preamplifier that substantially reproduces the classic vacuum tube sound where that preamplifier is incorporated into the stringed musical instrument.

Signals from stringed musical instruments frequently are amplified by amplifiers. Known amplifiers for stringed musical instruments generally are bulky, lack easy mobility and are powered by alternating current. What is needed is a stringed musical instrument incorporating a preamplifier that allows the user to substantially reproduce the classic vacuum tube amplifier sound, by incorporating a preamplifier in the instrument, where the preamplifier also is engineered to be amplified by a hi-fidelity stereo system, such as a direct current powered automobile stereo system.

Additionally, known preamplifier (“preamp”) designs are not as efficient and economical as they could be, and generally require vacuum tubes to generate the classic vacuum tube amplifier sound. Known vacuum tube based musical instrument amplifiers consists of one or more preamp stages, followed by a power output stage. The preamp stages are typically single-ended gain stages, while the power stage is commonly a class AB push-pull amplifier. Each type of stage contributes a distinct non-linear distortion characteristic to the amplifier, which when blended in suitable proportions can be used to add to the harmonic complexity of the amplified sound in a musically pleasing way. Harmonic accentuating characteristics typically are further enhanced by frequency response shaping elements, both incidental (such as inter-stage coupling circuits and parasitic elements), and intentional (such as variable tone controls, and fixed filter circuits).

The vacuum tube amplifier frequency response characteristics usually can be approximated accurately, but the non-linear characteristics are more difficult to reproduce with reasonable accuracy. A common technique for approximating the non-linear characteristics of a push-pull tube power output stage is shown in FIG. 3. For small signal operation, the conduction of the diodes is negligible and so the stage gain is defined simply by the ratio of the feedback resistors R1 and R2. For larger signals, the diodes will conduct current according to the familiar diode junction characteristic Id=Is(1+exp(Vdt)). In this case, the diodes represent a non-linear resistance in parallel with R1, tending to reduce the effective gain dynamically as the signal voltage increases. This process is known as ‘clipping’ or ‘hard compression’.

According to theory, a properly balanced push-pull output stage produces mainly odd-order harmonic distortion components due to its symmetry, whereas a single-ended amplifier stage, such as used in the preamp stages, will produce both odd and even order harmonic distortion due to its inherent asymmetry.

To attempt to approximate both the odd and even harmonics produced by a typical tube amplifier, the approach depicted in FIG. 3 is often modified to introduce asymmetry into the diode network, by, for example, using different diode types for positive and negative clipping, or using different numbers of diodes in series, as shown in FIG. 4, or by using resistive taps in the diode chains, or some combination of these approaches.

Whether symmetrical or asymmetrical in nature, simple diode clipping occurs rather abruptly as the signal voltage reaches the conduction threshold of the diodes in the clipping network. This is the opposite of the soft-compression characteristic of a single-ended vacuum tube gain stage; hence the overall approximation by simple diode clipping is poor for all but the heavily distorted case.

What is needed is a preamp that substantially reproduces the vacuum tube amplifier sound, using solid state electronics, which preamp is incorporated into a stringed musical instrument, and where the preamp is designed to operate through a direct current hi-fidelity stereo system, such as an automobile stereo system.

### SUMMARY OF THE INVENTION

This invention is an instrument-preamp combination designed for amplification through a hi-fidelity stereo system, and more particularly, through an automobile stereo system, where the preamp simulates the sound of analog tube amplifiers. The instrument-preamp combination (“Guitar”) comprises a known electric guitar and an analog vintage valve (vacuum tube) simulator (pedal) preamp built into the electric guitar. The preamp is designed with output parameters compatible with an automobile hi-fidelity stereo system that includes an amplifier and at least one speaker. A cable connects the preamp output to a hi-fidelity stereo system.

A novel preamp design improves approximation of amplification characteristics, both small and large signal, of typical musical instrument amplifiers based on vacuum tube technology, using only solid-state active devices in the preamp to achieve the desired sound.

### BRIEF DESCRIPTION OF THE DRAWINGS

These and other features, aspects and advantages of the present invention will become better understood with regard to the following description, appended claims ad accompanying drawings, in which:

FIG. 1 is a perspective view of the back of a guitar incorporated with a preamp;

FIG. 2 is a schematic of a known typical vacuum tube single-ended preamplifier stage;

FIG. 3 is a schematic of a known typical vacuum tube amplifier push-pull power output stage;

FIG. 4 is a schematic of a known approximation of a vacuum tube amplifier push-pull power output stage using symmetric diode clipping;

FIG. 5 is a schematic of a known approximation of a vacuum tube amplifier push-pull power output stage using asymmetric diode clipping;

FIG. 6 is a schematic of the new preamp stage that simulates a vacuum tube amplifier push-pull power output stage;

FIG. 7 is a schematic of an alternative new preamp stage that simulates a vacuum tube amplifier push-pull power output stage; and

FIG. 8 is a schematic of the preferred embodiment of the new preamp, also showing guitar pickups and a preamp output jack.

### DETAILED DESCRIPTION

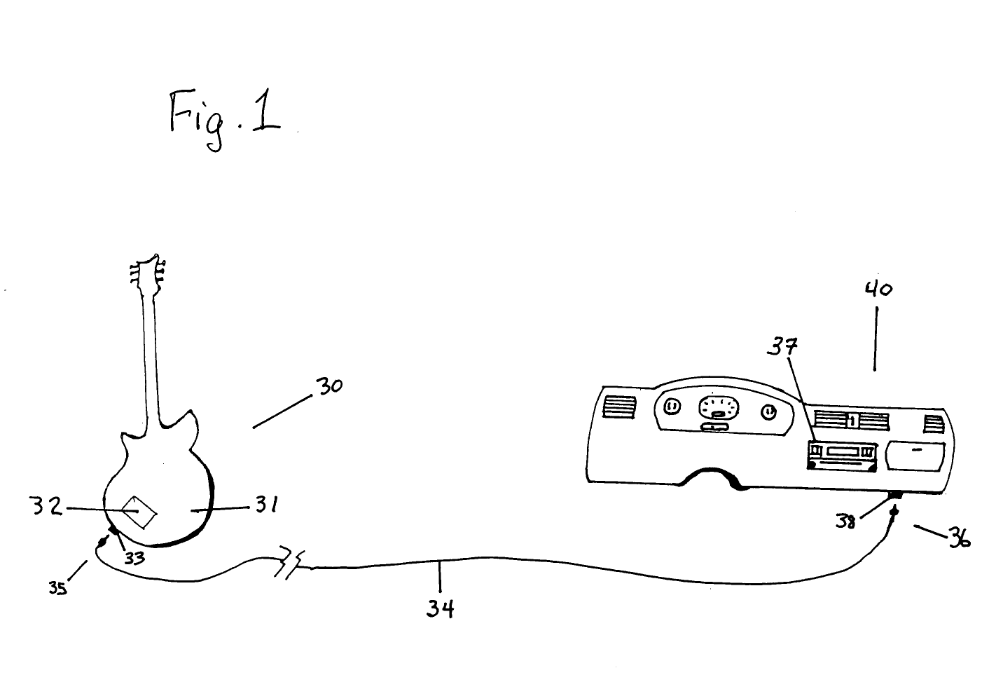

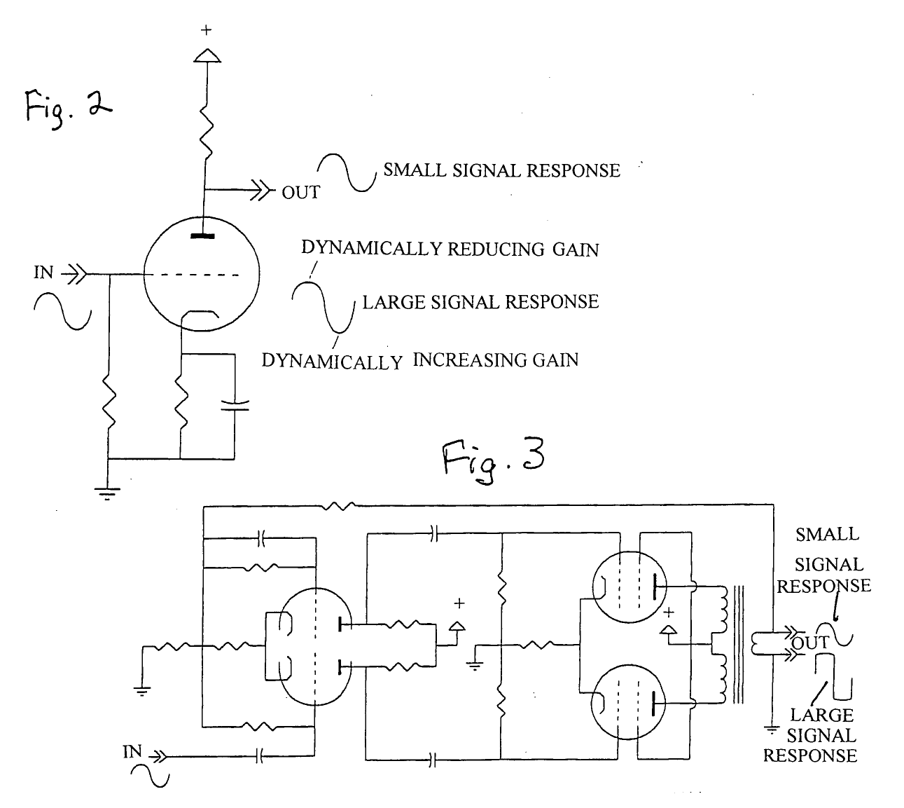

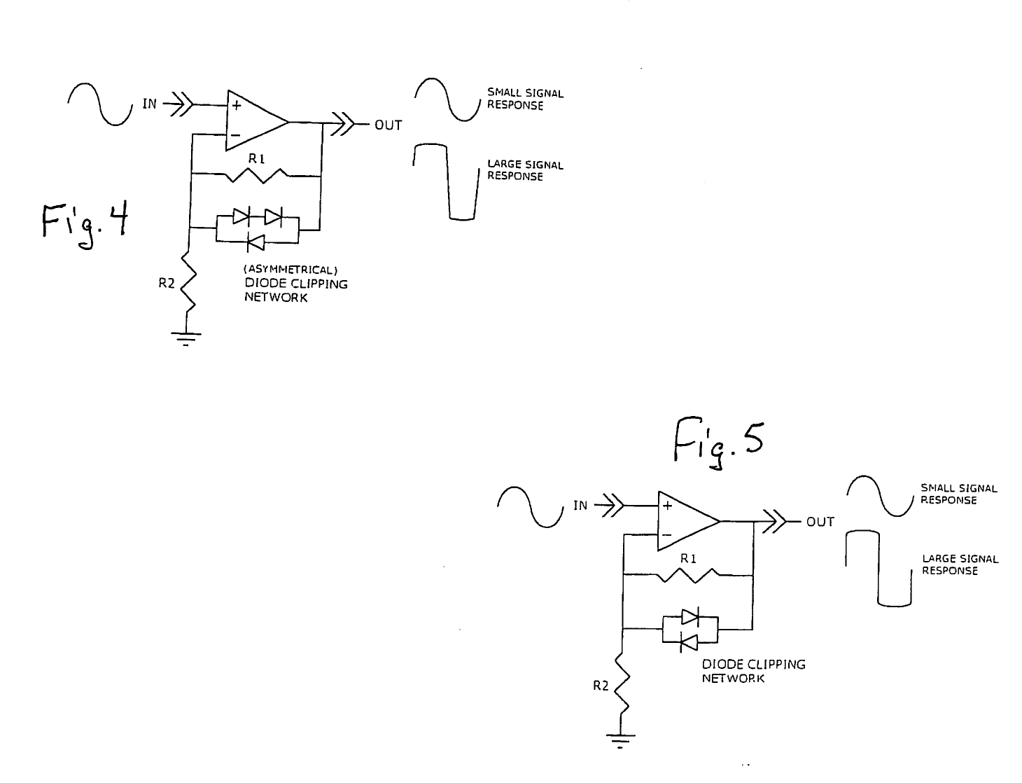

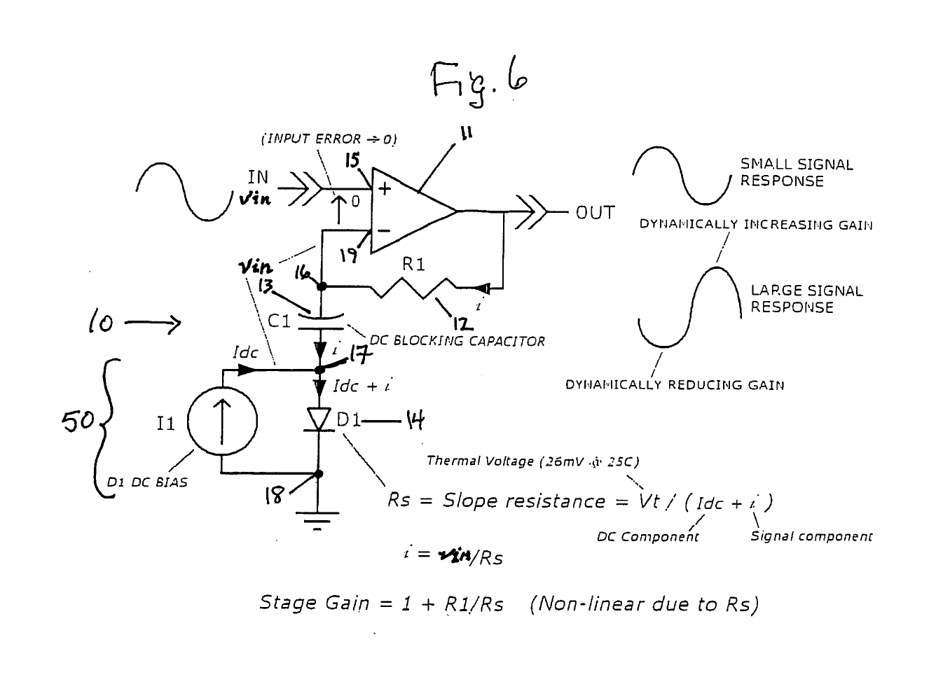

In vacuum tube amplifiers, the soft-compression characteristic of a single-ended tube gain stage is caused mainly by transconductance modulation effects, whereby the amplified signal modulates the gain of the stage dynamically through modulation of the plate current. FIG. 5 shows the basis for a new approach that uses a diode (D1) biased into its forward active region, and utilized as a non-linear resistive gain control element. This confers a signal-modulated gain characteristic upon the operational amplifier gain stage, which is analogous to the transconductance modulation effects present in the single-ended vacuum tube gain stage of FIG. 1.

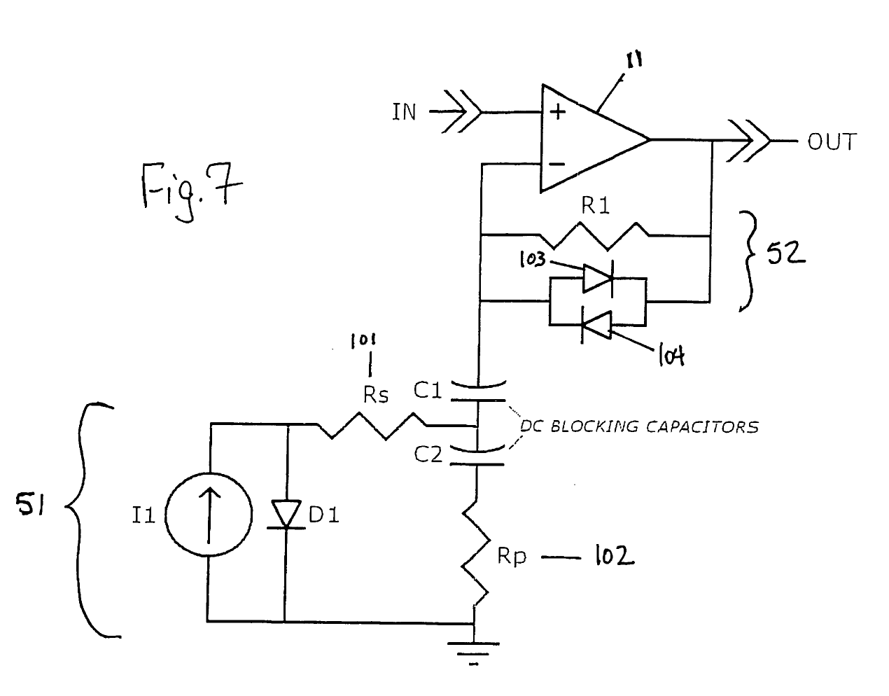

As shown in FIG. 6, the preamp stage circuit 10 comprises an first operational amplifier 11, a resistor R1, 12, a DC blocking capacitor C1 13, and a diode D1 14. The non-inverting input 19 of the first operational amplifier 11 is connected to a junction 16, to which resistor R1 12 and capacitor C1 13 are connected. The resistor R1 12 also is connected to the output of the first operational amplifier 11.

The capacitor C1 13 is connected to junction 17, which is connected to the diode D1 14 and the current source I1. The diode D1 14, and the current source I1 are also connected to junction 18, which is grounded. The current source typically will be in the order of 10-20 microamps to achieve a typical diode slope resistance of a few kilohms.

In the preamp stage shown in FIG. 6, there is a signal phase inversion produced by this particular embodiment of the circuit, when compared to the gain stage of FIG. 2. This is not material to its use as a guitar preamp, however, since absolute signal phase is not important to this preamp when used as described in this specification.

By suitable choice of circuit parameters and excitation levels, it is possible to achieve harmonic distortion characteristics (albeit scaled by absolute signal voltage level) very similar to those produced by the single-ended gain stage of FIG. 2.

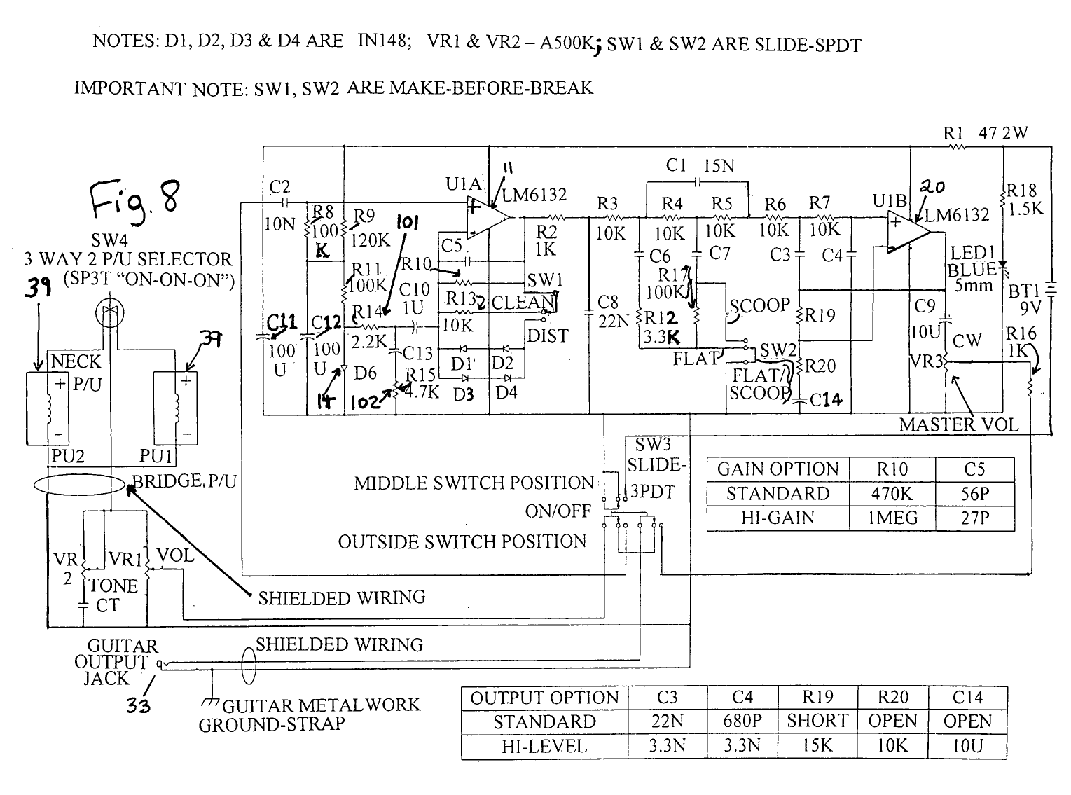

As shown in FIG. 8, the preamp input source is the signal provided by the guitar pickups 39 and the associated standard tone and volume control circuitry (i.e. the standard output signal from a conventional guitar). The preamp output is connected to a jack 33 on the Guitar housing 31, which can be connected to a high fidelity automobile stereo system 37 by a removable cable 34 having a standard ½ inch plug on the Guitar cable end 35, and a plug on the stereo system cable end 36. In the preferred embodiment, the cord 34 is well known, except that it uses a ⅛ inch plug on the stereo system cable end 36 to connect to the automobile stereo system, for compatibility with common stereo system auxiliary jacks. The automobile stereo system 37, typically mounted in an automobile dashboard 40, preferably has a compatible jack 38 electrically connected to the automobile stereo system so that the preamp signal is amplified by the automobile stereo system and the signal played through the automobile stereo system speakers (not shown).

The preamp output parameters preferably are tailored for 1 Volt (peak) and less than 5,000 ohms output impedance for compatibility with known automobile stereo systems, though the parameters may be varied for compatibility with different automobile stereo systems. The preamp output also can be modified for compatibility with numerous instrument amplifiers if the user prefers to amplify and play the preamp signal through systems other than an automobile stereo system. The preamp also is equipped with a switch which disconnects the preamplifier from the guitar pickup output so the guitar can be played through a valve or other amplifier customarily used to amplify known guitars.

FIG. 7 shows an alternative embodiment refining the circuit of FIG. 6. In the embodiment shown in FIG. 7, series and parallel resistors (Rs 101 and Rp 102 respectively) are added to the diode branch 50, shown in FIG. 6, as additional design optimization parameters to create the resistor modified diode branch 51.

FIG. 7 also shows symmetrical output clipping diodes 103 & 104, added across the R1 branch 52 to independently simulate a vacuum tube push-pull output stage characteristic. In the preferred embodiment shown in FIG. 8, there are four diodes, D1, D2, D3 & D4 in the R1 branch 52 (clipping-diode branch). The four diodes are connected in series, and alter the level at which clipping occurs. Different numbers of diodes could be used in series, depending on the particular optimal level of operation for the specific application.

Note that since the signal current flowing in the R1 branch 52 (clipping-diode branch) is determined by the input voltage impressed across the impedance of the resistor modified diode branch 51, the two branches, 51 & 52, can be thought of as representing two independent cascaded signal processing stages, while sharing a single operational amplifier as a common gain element. In this manner, the circuit provides an overall non-linear gain characteristic that is analogous to cascading a single-ended vacuum tube preamp with a push-pull vacuum tube output stage. The diode branch 50 (or the resistor for modified diode branch 51), and the R1 branch 52 (clipping diode branch) simulate two distinct valve amplifier stages. Without the R1 branch 52 (clipping diode branch), the preamp circuit simulates a single triode preamp stage. The two branches, the resistor modified diode branch 51 and the R1 branch 52 (clipping diode branch) are combined in a novel manner to achieve two cascaded processing stages using a single gain element, the first operational amplifier 11.

The preferred embodiment shown in FIG. 8 also includes a frequency shaping network (the flat/scoop circuit) located between the two operational amplifier stages, built around the first operational amplifier 11 and second operational amplifier 20. The frequency shaping network simulates the tone shaping circuits of typical tube amplifiers, which with the resistor modified diode branch 51 and the R1 branch 52, simulate both the non-linear and linear valve amplifier characteristics.

As discussed above, the first operational amplifier 11 serves as the single gain element for the two cascaded stages, the resistor modified diode branch 51 and the R1 branch 52 (clipping diode branch). The second operational amplifier 20 stage is a second order, low pass filter, having cutoff frequency fₒ and Q parameters chosen to simulate the sonic characteristics of a typical guitar speaker cabinet. This extends the simulator of the preamp to include the speaker of a valve amplifier system.

FIG. 8 shows the preferred embodiment of the new preamp, Guitar pickups and a Guitar housing jack 33. Guitar pickups 39 typically are mounted on the Guitar housing 31 underneath the strings (not shown). Switches, wire shielding, grounding, power sources, connecting circuitry and similar common components are ordinarily included in the invention, would be known to one familiar with the art, and are not described in detail.

We claim:

1. A stringed instrument and preamplifier combination comprising an electric guitar having a preamplifier, the preamplifier having solid state active devices which allow the preamplifier to simulate the sound of analog tube amplifiers.
